(19) United States
(12) Patent Application Publication
(10) Pub. No.: US 2008/0014320 A1
(43) Pub. Date: Jan. 17, 2008

(54) Small protein skimmer for aquiculture

(76) Inventor: Shih-Hui Liao, Luchu Hsiang (TW)

Correspondence Address: PYLE & PIONTEK, 221 N. LASALLE - ROOM 2036, CHICAGO, IL, 60601, US

(21) Appl. No.: 11/485,108

(22) Filed: Jul. 12, 2006

(51) Int. Cl. A23L 1/164

(52) U.S. Cl. 426/241; 119/200

(57) ABSTRACT

A small protein skimmer for aquiculture includes a sealed body, a liquid-gas mixed pump motor, a protein foam collection device and a suspensory support. The sealed body is divided into foam generated grooves and flow gathered grooves by partitions, and the generated grooves connect with the flow gathered grooves at ends thereof. The liquid-gas mixed pump motor is mounted on bottoms of the foam generated grooves for pumping water and forming a liquid-gas mixed water flow in the foam generated grooves. The foam generated grooves define apertures in tops thereof which a protein foam collection device can insert into. A flow gathered groove defines a water outlet in a forward sidewall near a top thereof and an adjusting sluice on the water outlet for adjusting water output.

### BACKGROUND OF THE INVENTION

1. Field of the invention

The present invention relates to a small protein skimmer for aquiculture, and more especially to a small protein skimmer for aquiculture having small size, of which all the components are integrally formed therewith.

2. Description of the prior art

At present, most protein skimmers for aquiculture all have large size and only can be used in large culture ponds. When the protein skimmers need to be used in smaller culture ponds, they must be located out of the culture ponds and connect with the culture ponds through proper water inlet/outlet pipes. So these kinds of protein skimmers are inconvenient for installation and generally occupy larger space which causes environmental influences.

Although it has been attempted to miniaturize the protein skimmers, for the sake of seal of the protein skimmers and maintenance of pump motors, the protein skimmers and the pump motors are designed to be separated from each other, so that the protein skimmers are complicated in structure, which affect the appearance thereof.

### SUMMARY OF THE INVENTION

A primary object of the present invention is to provide a small protein skimmer for aquiculture which forms a sealed body including foam generated grooves and flow gathered grooves whose ends are connected, by quickly assembling a rear shell and a front cover via a girding device of a suspensory support, and arranges a liquid-gas mixed pump motor in the foam generated grooves so that a lot of air bubbles generate in the foam generated grooves and makes protein contaminates in aquiculture water rise and gather in a protein foam collection device above the foam generated grooves.

Another object of the present invention is to provide a small protein skimmer for aquiculture of which a sealed body can be hung or sucked on a sidewall of an aquaculture tank via a suspensory support with hang-up function or suck function.

### BRIEF DESCRIPTION OF THE DRAWINGS

FIG. 1 is an exploded perspective view of a first embodiment of a small protein skimmer for aquiculture in accordance with the present invention;

FIG. 1A is a perspective view of an adjusting sluice of the small protein skimmer for aquiculture in accordance with the present invention;

FIG. 1B is an exploded perspective view of a suspensory support of the small protein skimmer for aquiculture in accordance with the present invention;

FIG. 2 is an assembled perspective view of the small protein skimmer for aquiculture in accordance with the present invention;

FIG. 3 is a sectional view along the forward and backward direction of foam generated grooves of the small protein skimmer for aquiculture in accordance with the present invention;

FIG. 4 is a perspective view of the small protein skimmer for aquiculture in accordance with the present invention mounted on an aquaculture tank;

FIG. 5 is a perspective view of the small protein skimmer for aquiculture in accordance with the present invention mounted on the aquaculture tank in another state;

FIG. 6 is a sectional view along the direction of both sides of the small protein skimmer for aquiculture in accordance with the present invention, wherein a water level therein is lower;

FIG. 7 is a sectional view along the direction of both sides of the small protein skimmer for aquiculture in accordance with the present invention, wherein the water level therein is higher;

FIG. 8 is a perspective view of a second embodiment of the small protein skimmer for aquiculture in accordance with the present invention;

FIG. 9 is a perspective view of a third embodiment of the small protein skimmer for aquiculture in accordance with the present invention.

### DETAILED DESCRIPTION OF THE INVENTION

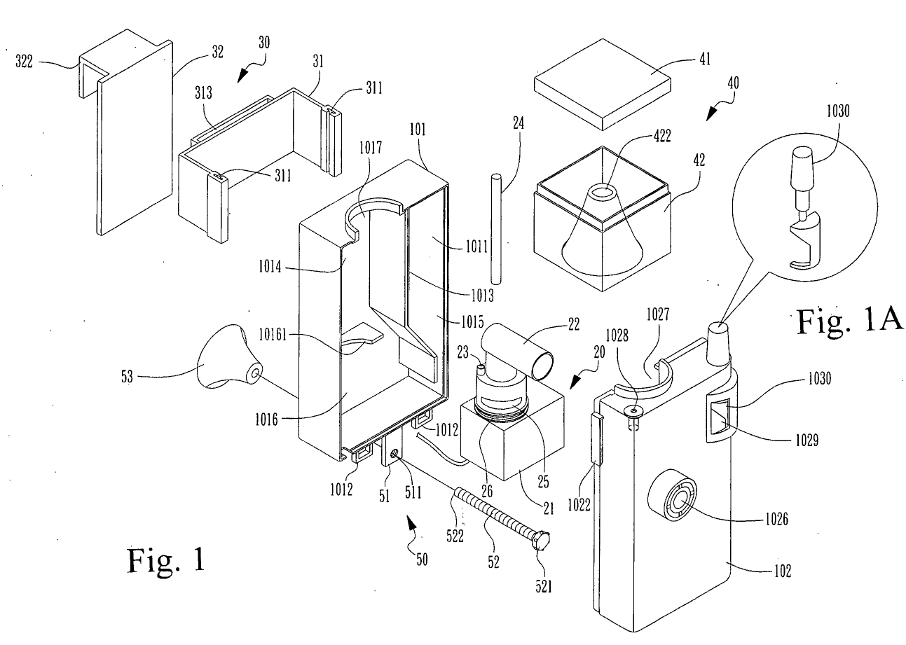

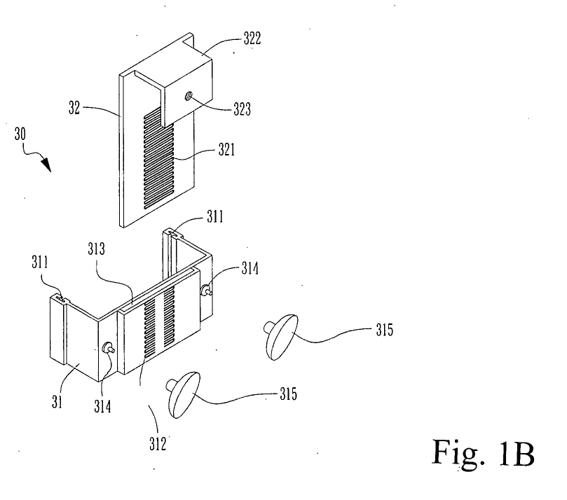

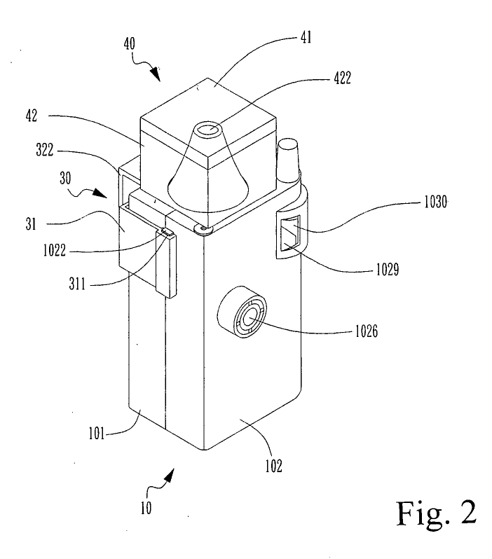

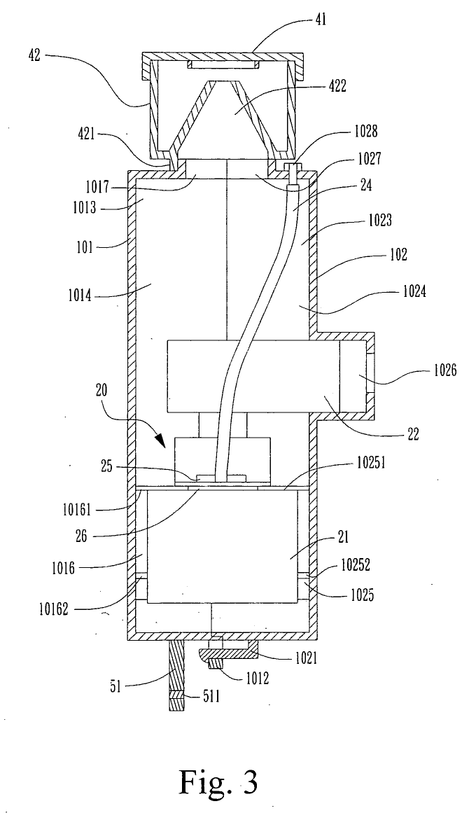

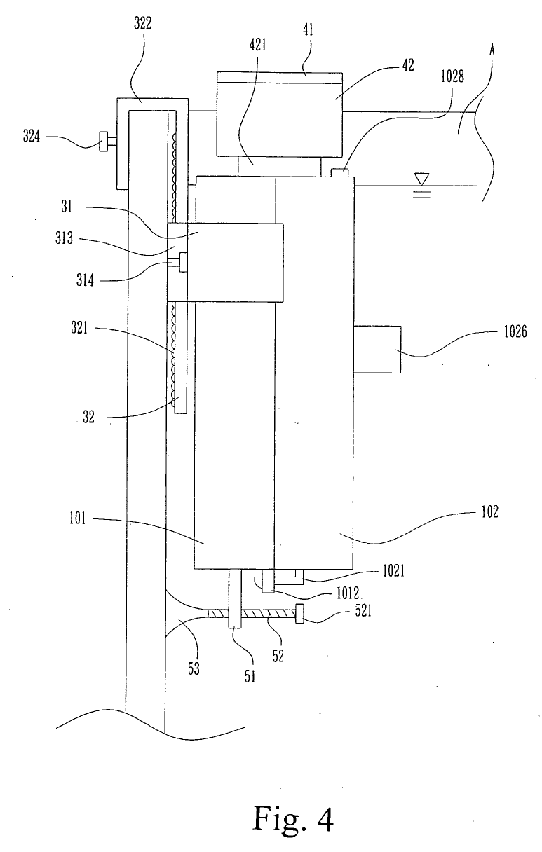

FIGS. 1-7 show a first embodiment of a small protein skimmer for aquiculture in accordance with the present invention. The small protein skimmer is mounted in an aquaculture tank A (shown in FIGS. 3 and 4) to remove protein contaminates from aquiculture water therein.

Referring to FIG. 1, the small protein skimmer for aquiculture includes a sealed body 10, a liquid-gas mixed pump motor 20, a suspensory support 30 and a protein foam collection device 40. The sealed body 10 includes a rear shell 101 and a front cover 102, and the rear shell 101 has a forward opening 1011 and a plurality of grooves 1012 near the forward opening 1011 in a bottom of the rear shell 101. The rear shell 101 is divided into a latter half foam generated groove 1014 and a latter half flow gathered groove 1015 by a latter half partition 1013 extending downwards from a top of an inner side of the rear shell 101. An end of the latter half foam generated groove 1014 connects an end of the latter half flow gathered groove 1015. The latter half foam generated groove 1014 forms a latter half motor received portion 1016 at a bottom thereof and defines a latter half aperture 1017 in a top thereof.

The front cover 102 may engage with the real shell 101 at the forward opening 1011 thereof. The front cover 102 forms a plurality of clasps 1021 to engage with the grooves 1012 (shown in FIGS. 3, 4 and 5) on a bottom thereof, and respectively forms an inserting pole 1022 on corresponding outer sides thereof. The front cover 102 also has a former half partition 1023 thereinside, corresponding to the latter half partition 1013. The front cover 102 is divided into a former half foam generated groove 1024 and a former half flow gathered groove (not shown) by the former half partition 1023, corresponding to the latter half foam generated groove 1014 and the latter half flow gathered groove 1015, respectively. An end of the former half foam generated groove 1024 connects an end of the former half flow gathered groove. The former half foam generated groove 1024 forms a former half motor received portion 1025 at a bottom thereof which corresponds to the latter half motor received portion 1016 and a water inlet 1026 near the former half motor received portion 1025 in a forward sidewall. The former half foam generated groove 1024 defines a former half aperture 1027 in a top thereof, corresponding to the latter half aperture 1017, and an air inlet 1028 near the former half aperture 1027. The former half flow gathered groove defines a water outlet 1029 (shown in FIG. 1) in a forward sidewall near a top thereof. There is an adjusting sluice 1030 (shown in FIG. 1A) on the water outlet 1029 for adjusting water output. Otherwise, the water outlet 1029 can be defined in a sideward sidewall in a space formed by the latter half flow gathered groove 1015 and the formed half flow gathered groove (not shown).

The liquid-gas mixed pump motor 20 includes a motor body 21 and a water inlet pipe device 22 arranged on the motor body 21. The motor body 21 is mounted between the latter half motor received portion 1016 and the formed half motor received portion 1025. The water inlet pipe device 22 connects the water inlet 1026. An air inlet aperture 23 is formed near the water inlet pipe device 22. The liquid-gas mixed pump motor 20 connects with the air inlet 1028 through an air inlet pipe 24. A liquid-gas mixed water flow outlet 25 is defined beside lower parts of the water inlet pipe device 22 and the air inlet aperture 23.

To fix the liquid-gas mixed pump motor 20 better, a locking dented ring 26 is formed over the motor body 21, and the latter half motor received portion 1016 and the formed half motor received portion 1025 have locking pieces 10161 and 10251, respectively, corresponding to the locking dented ring 26. When the rear shell 101 engages with the front cover 102 to form the sealed body 10, the locking pieces 10161 and 10251 insert into a front side and a back side of the locking dented ring 26, respectively, thereby the liquid-gas mixed pump motor 20 can be fixed. Furthermore, the latter half motor received portion 1016 and the formed half motor received portion 1025 form holding blocks 10162 and 10262 respectively to hold sidewalls of the motor body 21, accordingly the liquid-gas mixed pump motor 20 can be mounted more fixedly in the sealed body 10.

The suspensory support 30 includes a girding device 31 and a suspensory piece 32. The girding device 31 includes a U-shaped fastener which has the approximately same width and depth as the rear shell 101. The U-shaped fastener defines sliding grooves 311 in inner sides of two ends thereof, respectively, and the inserting pole 1022 of the front cover 102 can slide from top to bottom into and then locate in the sliding grooves 311. A fixed inserting slot 313 with locking protrusions 312 inside is defined in a center located at rear, outside of U-shaped fastener. Since the bottom of the rear shell 101 engages with the bottom of the front cover 102 through the grooves 1012 and the clasps 1021, when the top of the rear shell 101 connects with the top of the front cover 102 and the inserting poles 1022 on the two sides of the front cover 102 insert into the sliding grooves 311 of the girding device 31 from top to bottom, simultaneously, the rear shell 101 and the front cover 102 tightly engage with each other to be the sealed body 10.

The suspensory piece 32 includes a piece which may be inserted into the fixed inserting slot 313. The piece includes sliding protrusions 321 corresponding to the locking protrusions 312 and a hook portion 322 ∩-shaped and bending backwards on a top thereof. A bolt hole 323 is defined in an outer wall of the hook portion 322 and engages with a fixing bolt 324 (shown in FIG. 4) to fix the hook portion 322 on an upper margin of a sidewall of the aquaculture tank A.

Since the suspensory piece 32 may be inserted into the fixed inserting slot 313 of the girding device 31, the mounted position of the sealed body 10 can be adjusted in the longitudinal direction through the engagement between the sliding protrusions 321 of the suspensory piece 32 and the locking protrusions 312 of the fixed inserting slot 313.

In addition, the girding device 31 forms one suction disk fixed inserting pole 314 at each side of the fixed inserting slot 313. When the girding device 31 of the suspensory support 30 does not engage with the suspensory piece 32, a suction disk 315 can be arranged directly on the suction disk fixed inserting pole 314 and sucks on an inner side of the sidewall of the aquaculture tank A to fix the sealed body 10.

Furthermore, the sealed body 10 forms a vertically adjusting and fixing device 50 on the bottom thereof for vertically adjusting and fixing the small protein skimmer for aquiculture. In the embodiment of the present invention, the vertically adjusting and fixing device 50 is positioned in a center of the bottom of the rear shell 101 and includes a vertical piece 51, a revolving screwing rod 52 and a cupule 53. The vertical piece 51 defines a screwing hole 511 extending forwards and backwards therein. The revolving screwing rod 52 has a revolving head portion 521 on an outside end thereof, besides being engaged in the screwing hole 511. The cupule 53 engages with an inside end of the revolving screwing rod 52 at an end thereof.

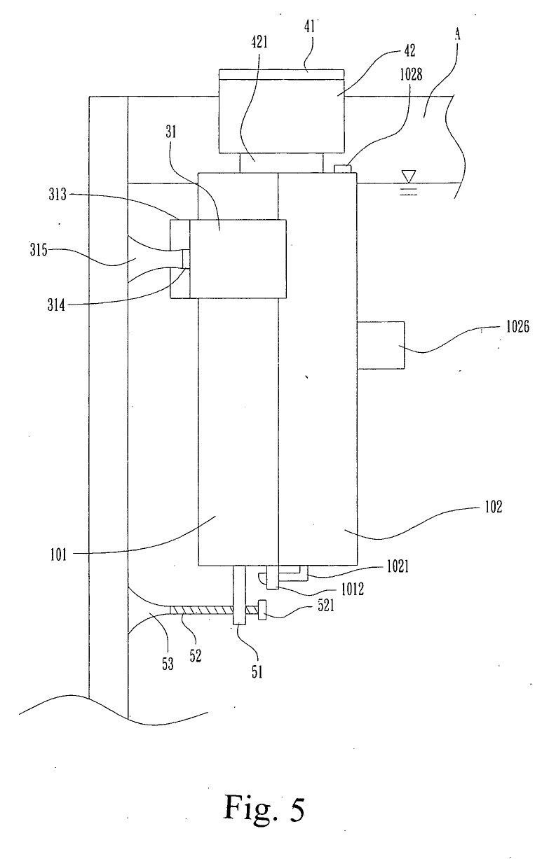

When the sealed body 10 is mounted on the sidewall of the aquaculture tank A through the suspensory piece 32 or the suction disk 315, the bottom of the sealed body 10 inclines towards the sidewall of the aquaculture tank A. In order to skim protein foam in the aquiculture water effectively, at first, revolve the revolving screwing rod 52 to make the cupule 53 at the end thereof suck on the sidewall of the aquaculture tank A, then continue to revolve the revolving screwing rod 52 and make the bottom of the sealed body 10 gradually form a vertical state along with the driving of the vertical piece 51 (shown in FIG. 4 or 5).

The protein foam collection device 40 includes a trough body 42 which has a cover 41 on a top thereof. The trough body 42 includes a hollow fixing base 421 (shown in FIG. 3) on a bottom thereof and a foam guiding way 422. The hollow fixing base 421 extends through the bottom of the trough body 52 and can be set on the latter half aperture 1017 and the former half aperture 1027. The foam guiding way 422 extends upwards from the hollow fixing base 421, with a aperture diameter thereof becoming smaller and smaller, and till a top of the foam guiding way 422 is close to an inner wall of the cover 41.

In practice, the sealed body 10 must be mounted in the aquaculture tank A and the air inlet 1028 on the top of the sealed body 10 is out of a surface of the aquaculture water, as shown in FIG. 4 or 5. Otherwise, because the protein foam collection device 40 is mounted on the sealed body 10, a water level of the water in the sealed body 10 must approach the bottom of the hollow fixing base 421 of the protein foam collection device 40 at least, in order to make the protein foam generated in the sealed body 10 rise along the foam guiding way 422 and gather in the trough body 42 of the protein foam collection device 40.

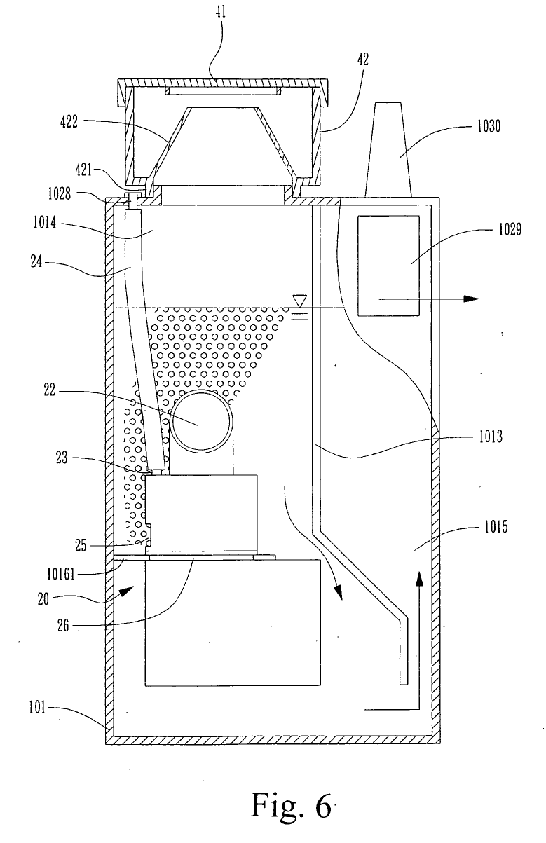

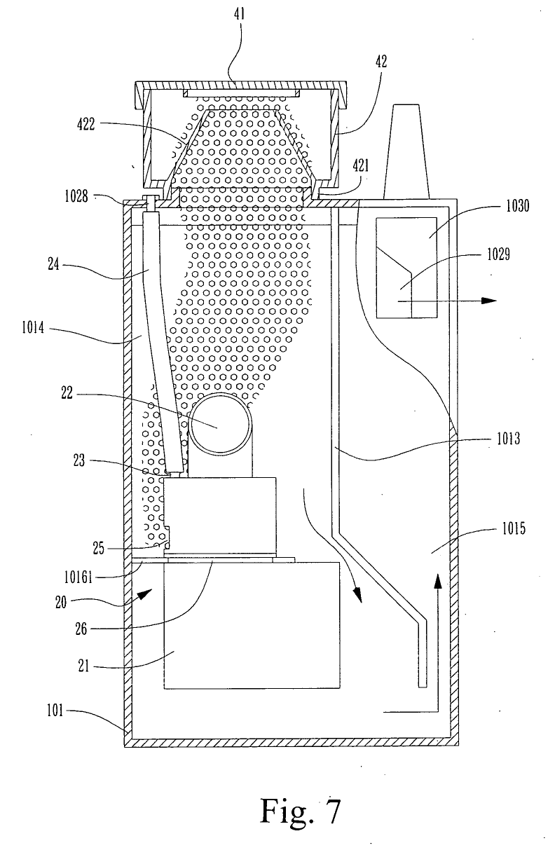

Since there is the adjusting sluice 1030 on the water outlet 1029, even when the water level of the water in the sealed body 10 is slightly far away from the bottom of the hollow fixing base 421 (shown in FIG. 6), the water level of the water in the sealed body 10 can rise and approach the bottom of the hollow fixing base 421 (shown in FIG. 7) by adjusting the adjusting sluice 1030 to make the water output of the water outlet 1029 less than water input of the water inlet 1026. So if there is no adjusting sluice set on the water outlet 1029 for adjusting the water output, the sealed body 10 must be soaked by enough water till the water level in the sealed body 10 approaches the bottom of the hollow fixing base 421.

Referring to FIGS. 3 and 7, when the liquid-gas mixed pump motor 20 works, the aquaculture water flows into the water inlet pipe device 22 via the water inlet 1026. At this time, the flow mixes with air from the air inlet aperture 23 into a liquid-gas mixed water flow, which jets out from the liquid-gas mixed water flow outlet 25. Air bubbles in the liquid-gas mixed water flow rise and float in a space formed by the latter half foam generated groove 1014 and the formed half foam generated groove 1024, form a lot of pushing and shoving therebetween and enter the trough body 42 through the foam guiding way 422 of the protein foam collection device 40, thereby protein impurities attached on surfaces of the air bubbles are left on the bottom of the trough body 42 to achieve filtration of the aquaculture water.

Because the air bubbles gather at an upper part in the space formed by the latter half foam generated groove 1014 and the formed half foam generated groove 1024, the filtered aquaculture water without air bubbles will flow into the space formed by the latter half flow gathered groove 1015 and the formed half flow gathered groove (not shown) via the bottoms of the latter half partition 1013 and the former half partition 1023, and then flow back to the aquaculture tank A from the water outlet 1029 above the space, to achieve the purpose of skimming the protein foam in the aquiculture water.

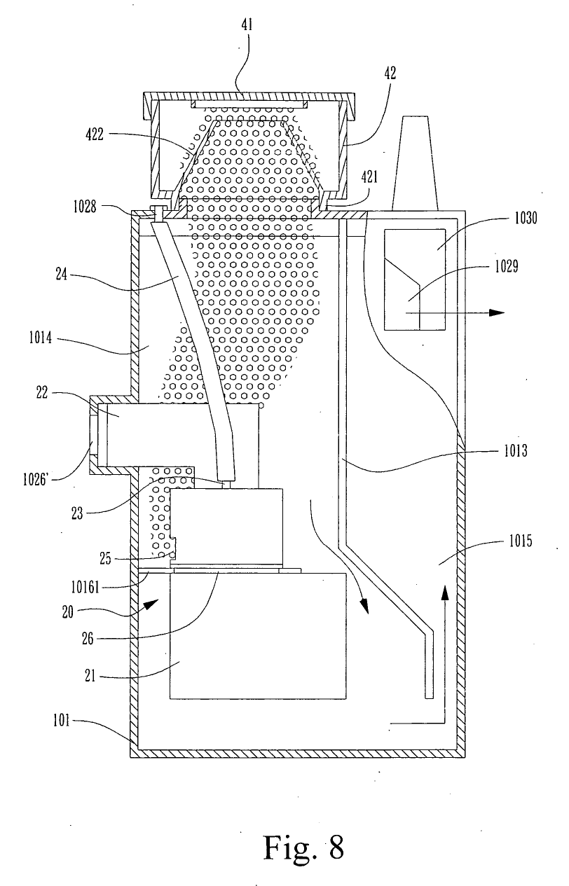

FIG. 8 shows a second embodiment of the small protein skimmer for aquiculture in accordance with the present invention. The difference between the second embodiment and the first embodiment is that a water inlet 1026′ of the second embodiment is defined in a sideward sidewall in the space formed by the latter half foam generated groove 1014 and the formed half foam generated groove 1024, and the water inlet pipe device 22 of the second embodiment is inserted correspondingly in the water inlet 1026′ as an entrance for the aquaculture water.

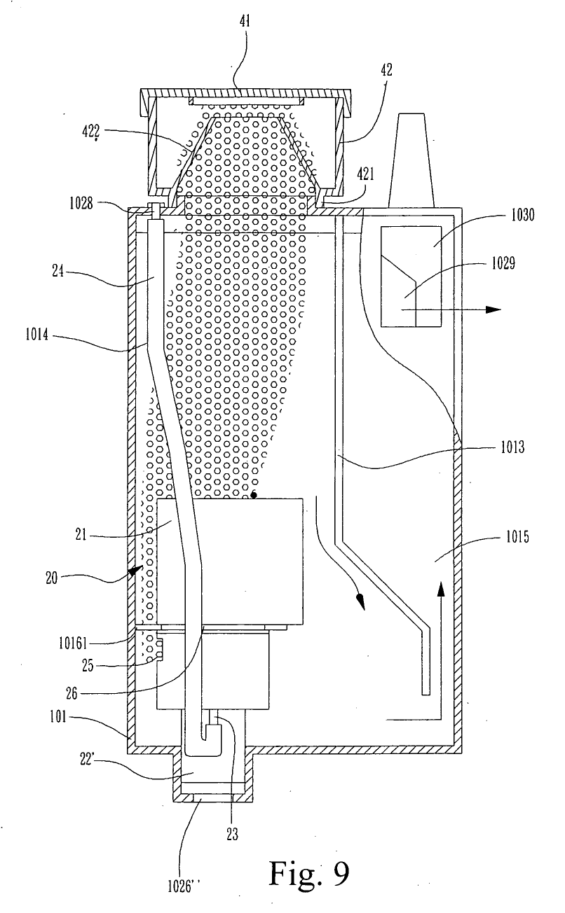

FIG. 9 shows a third embodiment of the small protein skimmer for aquiculture in accordance with the present invention. The difference between the third embodiment and the first embodiment is that a water inlet 1026″ of the third embodiment is defined in a bottom sidewall in the space formed by the latter half foam generated groove 1014 and the formed half foam generated groove 1024, the liquid-gas mixed pump motor 20 of the third embodiment is mounted upside down and the water inlet pipe device 22′ of the third embodiment is inserted upwards directly in the water inlet 1026″ as an entrance for the aquaculture water.

What is disclosed above only is the preferred embodiments of the present invention, and therefore it is intended that the present invention not be limited to the particular embodiments disclosed. So it will be understood by those skilled in the art that various equivalent changes may be made depending on the specification and the drawings of present invention without departing from the scope of the present invention.

What is claimed is:

1. A small protein skimmer for aquiculture, mounted in an aquiculture tank for removing protein contaminates from aquiculture water of the aquiculture tank, comprising:
a sealed body, having:
a rear shell, having a forward opening and a plurality of grooves near the forward opening in a bottom of the rear shell and being divided into a latter half foam generated groove and a latter half flow gathered groove by a latter half partition extending downwards from a top of an inner side of the rear shell, an end of the latter half foam generated groove connecting an end of the latter half flow gathered groove, the latter half foam generated groove forming a latter half motor received portion at a bottom thereof and defining a latter half aperture in a top thereof; and
a front cover, engaging with the real shell at the forward opening, forming a plurality of clasps to engage with the grooves on a bottom thereof, forming an inserting pole on corresponding outer sides thereof, respectively, having a former half partition thereinside corresponding to the latter half partition, and being divided into a former half foam generated groove and a former half flow concentrated groove by the former half partition, corresponding to the latter half foam generated groove and the latter half flow concentrated groove, respectively, an end of the former half foam generated groove connecting an end of the former half flow concentrated groove, the former half foam generated groove forming a former half motor received portion at a bottom thereof which corresponds to the latter half motor received portion and a water inlet near the former half motor received portion in a forward sidewall thereof, the former half foam generated groove defining a former half aperture in a top thereof corresponding to the latter half aperture and an air inlet near the former half aperture, the former half flow gathered groove defining a water outlet in a forward sidewall near a top thereof and forming an adjusting sluice on the water outlet for adjusting water output;
a liquid-gas mixed pump motor, mounted between the latter half motor received portion and the formed half motor received portion and including a water inlet pipe device connecting the water inlet and an air inlet aperture near the water inlet pipe device connecting with the air inlet via an air inlet pipe, a liquid-gas mixed water flow outlet defined beside lower parts of the water inlet pipe device and the air inlet aperture;
a suspensory support, having:
a girding device having a U-shaped fastener which has the approximately same width and depth as the rear shell, the U-shaped fastener defining a sliding groove in each inner side of two ends thereof for the inserting pole of the front cover sliding from top to bottom into and being located in the sliding groove, and a fixed inserting slot with a locking protrusion inside in a center located at rear, outside thereof; and
a suspensory piece having a piece for being inserted into the fixed inserting slot, the piece including a sliding protrusion corresponding to the locking protrusion and a hook portion ∩-shaped and bending backwards on a top thereof;
a vertically adjusting and fixing device, having:
a vertical piece, of which top is mounted on a bottom of the sealed body, defining a screwing hole extending forwards and backwards therein;
a revolving screwing rod engaging with the screwing hole and forming a revolving head portion on an outside end thereof; and
a cupule engaging with an inside end of the revolving screwing rod at an end thereof; and
a protein foam collection device 40 having a trough body, the trough body having a cover on a top thereof, a hollow fixing base on a bottom thereof and a foam guiding way, the hollow fixing base extending through the bottom of the trough body and mounted on the latter half aperture and the former half aperture, the foam guiding way extending upwards from the hollow fixing base, with a aperture diameter being smaller and smaller and a top close to an inner wall of the cover.

2. The small protein skimmer for aquiculture as claimed in claim 1, wherein the water inlet is defined in a sideward sidewall in a space formed by the latter half foam generated groove and the formed half foam generated groove.

3. The small protein skimmer for aquiculture as claimed in claim 1, wherein the water inlet is defined in a bottom sidewall in a space formed by the latter half foam generated groove and the formed half foam generated groove.

4. A small protein skimmer for aquiculture, mounted in an aquiculture tank for removing protein contaminates from aquiculture water of the aquiculture tank, comprising:
a sealed body, having:
a rear shell, having a forward opening and a plurality of grooves near the forward opening in a bottom of the rear shell and being divided into a latter half foam generated groove and a latter half flow gathered groove by a latter half partition extending downwards from a top of an inner side of the rear shell, an end of the latter half foam generated groove connecting an end of the latter half flow gathered groove, the latter half foam generated groove forming a latter half motor received portion at a bottom thereof and defining a latter half aperture in a top thereof; and
a front cover, engaging with the real shell at the forward opening, forming a plurality of clasps to engage with the grooves on a bottom thereof, forming an inserting pole on corresponding outer sides thereof, respectively, having a former half partition thereinside corresponding to the latter half partition, and being divided into a former half foam generated groove and a former half flow concentrated groove by the former half partition, corresponding to the latter half foam generated groove and the latter half flow concentrated groove, respectively, an end of the former half foam generated groove connecting an end of the former half flow concentrated groove, the former half foam generated groove forming a former half motor received portion at a bottom thereof which corresponds to the latter half motor received portion and a water inlet near the former half motor received portion in a forward sidewall thereof, the former half foam generated groove defining a former half aperture in a top thereof corresponding to the latter half aperture and an air inlet near the former half aperture, the former half flow gathered groove defining a water outlet in a forward sidewall near a top thereof and forming an adjusting sluice on the water outlet for adjusting water output;
a liquid-gas mixed pump motor, mounted between the latter half motor received portion and the formed half motor received portion and including a water inlet pipe device connecting the water inlet and an air inlet aperture near the water inlet pipe device connecting with the air inlet via an air inlet pipe, a liquid-gas mixed water flow outlet defined beside lower parts of the water inlet pipe device and the air inlet aperture;
a suspensory support, having:
a girding device having a U-shaped fastener which has the approximately same width and depth as the rear shell, the U-shaped fastener defining a sliding groove in each inner side of two ends thereof for the inserting pole of the front cover sliding from top to bottom into and being located in the sliding groove, and a plurality of suction disk fixed inserting poles at rear, outside thereof and extending backwards; and
a plurality of suction disk arranged on the suction disk fixed inserting poles, respectively;
a vertically adjusting and fixing device, having:
a vertical piece, of which top is mounted on a bottom of the sealed body, defining a screwing hole extending forwards and backwards therein;
a revolving screwing rod engaging with the screwing hole and forming a revolving head portion on an outside end thereof; and
a cupule engaging with an inside end of the revolving screwing rod at an end thereof; and
a protein foam collection device having a trough body, the trough body having a cover on a top thereof, a hollow fixing base on a bottom thereof and a foam guiding way, the hollow fixing base extending through the bottom of the trough body and mounted on the latter half aperture and the former half aperture, the foam guiding way extending upwards from the hollow fixing base, with a aperture diameter being smaller and smaller and a top close to an inner wall of the cover.

5. The small protein skimmer for aquiculture as claimed in claim 4, wherein the water inlet is defined in a sideward sidewall in a space formed by the latter half foam generated groove and the formed half foam generated groove.

6. The small protein skimmer for aquiculture as claimed in claim 4, wherein the water inlet is defined in a bottom sidewall in a space formed by the latter half foam generated groove and the formed half foam generated groove.
